(19) United States
(12) Patent Application Publication
(10) Pub. No.: US 2015/0288192 A1
(43) Pub. Date: Oct. 8, 2015

(54) Power source and power source voltage regulating method

(71) Applicant: ZTE Corporation, Shenzhen, Guangdong (CN)

(72) Inventors: Linguo Wang, Shenzhen (CN); Bin Zhang, Shenzhen (CN)

(21) Appl. No.: 14/436,173

(22) PCT Filed: Jun. 25, 2013
(86) PCT No.: PCT/CN2013/077938

§ 371 Date: Apr. 16, 2015

(30) Foreign Application Priority Data
Oct. 16, 2012 (CN) 201210393107.8

(51) Int. Cl. H02J 4/00

(52) U.S. Cl. CPC H02J 4/00

(57) ABSTRACT

A power source and a power source voltage regulating method are described. The power source includes: a current source device, a voltage source device, and a voltage selection device. The current source device is configured to provide a current signal to the voltage source device; the voltage source device is connected to the current source device, includes multiple voltage sources, and is configured to convert the current signal from the current source device into a voltage signal; and the voltage selection device is connected to the voltage source device, and is configured to select one of voltage signals from multiple voltage sources as an output voltage signal. By means of the disclosure, one current source device is used to supply power to multiple voltage sources in the voltage source device, so as to maintain the output voltages (V₁ to V_{N}) of the voltage sources stable; the voltage selection device selects the output of one of the voltage sources as an ultimate output voltage (Vₒᵤₜ) according to an actual voltage regulating demand, thereby significantly simplifying the structure of a multi-input power source, hence reducing the volume of the power source, reducing the cost, and improving the efficiency.

### TECHNICAL FIELD

The disclosure relates to the field of communications, in particularly to a power source and a power source voltage regulating method.

### BACKGROUND

In an electronic device, a power source is required to provide a rapid voltage regulating function in many occasions in order to minimize energy consumption, e.g. a Central Processing Unit (CPU) power supply, a power supply of a radio frequency power amplifier etc., and more typically, a power supply device of the radio frequency power amplifier.

In order to meet increasing demands of users for bandwidths, modulation modes of a communication system are becoming more and more complicated, and a prominent problem is low efficiency of radio frequency power amplifiers, which has become a bottleneck for the improvement of the whole communication system. In order to ensure the linearity of a linear power amplifier, a power supply voltage should be higher than a radio frequency signal peak voltage. Under the conventional direct current power supply mode, a power source output voltage is designed according to the maximum output power of a power amplifier, which results in low efficiency of the power amplifier and serious waste of electric energy when the output power of the power amplifier is relatively low. Therefore, the reduction of power amplifier loss has become the key of energy conservation and emission reduction of the communication system.

In the related arts, in order to improve the efficiency of a power amplifier under different output power, corresponding regulation is generally applied to a power supply voltage, i.e. a relatively high power supply voltage is applied when the output power of the power amplifier is relatively high while a relatively low power supply voltage is applied when the output power of the power amplifier is relatively low. Since voltage regulation of existing power source technologies is relatively slow, the existing power amplifier voltage regulation power supply technology is only applied to changes of output power in a relatively long period of time, e.g. when communication services are busy during daytime, an amplifier is close to its maximal output power and a relatively high voltage is applied for power supply; when there are less services at midnight, the output power of the amplifier is relatively low and a relatively low voltage is applied for power supply. Limited by the voltage regulation speed of the existing power source technologies, efficiency improvement for power amplifiers is limited using the solution above.

To further improve the efficiency of power amplifiers, the voltage regulation speed of power sources needs to be further increased. FIG. 1 is a structural diagram of a regular power source in the related arts. As shown in FIG. 1, the power source is a typical switch power source which has advantages of low loss and high efficiency because a power semiconductor thereof only works under an on/off state. The working principle is that, chopping is performed for an input power source 101 through complementary connection of switches 102 and 103, and different output voltages are acquired after subsequent filtering performed by an inductor 104 and a capacitor 105 according to the width of a chopping pulse signal. However, limited by low frequency filtering of the inductor and the capacitor, voltage regulation of such a power source is slow. The chopping frequency needs to be improved in order to accelerate the voltage regulation of the power source. At this point, losses of the switches 102 and 103 are increased accordingly. In addition, the capacitor 105 needs to be charged and discharged during the voltage regulation, and a relatively large charging and discharging current is required by a relatively high voltage regulating speed, which increases the conduction loss and reduce the power source conversion efficiency accordingly. Therefore, the power source shown in FIG. 1 is not applicable to rapid voltage regulation.

FIG. 2 is a structural diagram of a power source capable of rapid voltage regulation according to the related art. As shown in FIG. 2, rapid voltage regulation is performed by gating output of multiple independent input power sources 201, 202 and 203, i.e. when a switch 204 is turned on, the input power source 201 is connected to an output voltage (i.e. the output voltage of the whole power source is V₁); when a switch 205 is turned on, the input power source 202 is connected (i.e. the output voltage of the whole power source is V₂); when a switch 206 is turned on, the input power source 203 is connected (i.e. the output voltage of the whole power source is V₃). An output capacitor does not need to be charged and discharged during voltage regulation, thus improving the voltage regulation speed and efficiency. However, since multiple independent input power sources are needed, and generally, each independent input power source 201, 202 or 203 at least includes a group of devices consisting of two switches, one inductor and one capacitor etc. As shown in FIG. 1, there are problems of large power source volume, high cost and low efficiency.

### SUMMARY

Embodiments of the disclosure provide a power source and a power source voltage regulating method to at least solve the problems of slow voltage regulation and low efficiency of a voltage regulating power source in the related art.

According to an aspect of the embodiments of the disclosure, a power source is provided, which includes: a current source device, a voltage source device, and a voltage selection device, wherein
the current source device may be configured to provide a current signal to the voltage source device;
the voltage source device may be connected to the current source device, may include multiple voltage sources, and may be configured to convert the current signal from the current source device into a voltage signal;
the voltage selection device may be connected to the voltage source device, and may be configured to select one of voltage signals from multiple voltage sources as an output voltage signal.

Preferably, the current source device may include: a first input power source, a first switch, a second switch and a first inductor, wherein
a cathode of the first input power source may be grounded, and an anode may be connected to one end of the first switch;
the other end of the first switch may be connected to the second switch and the first inductor, and the second switch may be grounded;
the other end of the first inductor may be an output end of the current source device.

Preferably, the current source device may further include an isolating circuit, wherein the isolating circuit may include one of the followings: a forward converter, a flyback converter, a bridge circuit and a push-pull circuit; an isolating device in the isolating circuit may be a transformer.

Preferably, the current source device may further include a third switch, wherein
one end of a primary side of the transformer may be connected to the anode of the first input power source, and the other end may be connected to one end of the third switch; the other end of the third switch may be connected to the cathode of the input power source;
one end of a secondary side of the transformer may be connected to the first switch, and the other end may be connected to the grounded end of the second switch.

Preferably, the current source device may include: a second input power source, a second inductor and a fourth switch, wherein
a cathode of the second input power source may be grounded, and an anode may be connected to one end of the second inductor;
the other end of the inductor may be an output end of the current source device and connected to one end of the fourth switch, and the other end of the fourth switch may be grounded.

Preferably, the current source device may further include: a third input power source, an insolating circuit and a fifth switch; the isolating circuit may include one of the followings: a forward converter, a flyback converter, a bridge circuit and a push-pull circuit; an isolating device in the isolating circuit may be a transformer.

Preferably, a cathode of the third input power source may be grounded and an anode may be connected to one end of a primary side of the transformer; the other end of the primary side may be connected to one end of the fifth switch; the other end of the fifth switch may be connected to the cathode of the third input power source; one end of a secondary side of the transformer may be an output end of the current source device and the other end may be grounded.

Preferably, the voltage source may include: a sixth switch and a capacitor; one end of the sixth switch may be connected to the current source device, the other end may be an output end of the voltage source device and connected to one end of the capacitor; the other end of the capacitor may be grounded.

Preferably, the voltage selection device may include multiple switches respectively connected to multiple voltage sources in the voltage source device.

Preferably, the switches may include at least one of the followings: triodes, Metal-Oxide-Semiconductor (MOS) tubes, diodes, and Junction Field-Effect Transistors (JFET).

According to another aspect of the embodiments of the disclosure, a power source voltage regulating method is provided, applying any one of the power sources above. The method includes: inputting, by a current source device, a current signal to a voltage source device;
converting, by multiple voltage sources in the voltage source device, the current signal into a voltage signal respectively;
selecting, by a voltage selection device, one of multiple voltage signals as an output voltage signal.

Preferably, the selecting one of the multiple voltage signals as the output voltage signal by the voltage selection device may include:
acquiring, by the voltage selection device, different voltage magnitudes as the output voltage signals through turning on different switches.

Preferably, the acquiring different voltage magnitudes through turning on different switches by the voltage selection device may include:
turning on a switch in a voltage source, which is connected to a turned-on switch in the voltage selection device; a capacitor in the voltage source and the current source device may form a voltage-stabilizing direct current power source to maintain voltage stabilization of the output of the power source under a load.

Preferably, the inputting the current signal to the voltage source device by the current source device may include:
controlling an input power source in the current source device to charge an inductor;
when a switch in the voltage source is turned on, charging, by a current of the inductor, a capacitor in the voltage source.

Preferably, when the voltage source and a switch in the voltage selection device connected to the voltage source are disconnected, maintaining an output voltage of the voltage source by a capacitor in the voltage source.

Through the embodiments of the disclosure, one current source device is used to supply power to multiple voltage sources in the voltage source device, so as to maintain the output voltages (V₁ to V_{N}) of the voltage sources stable; the voltage selection device selects the output of one of the voltage sources as an ultimate output voltage (Vₒᵤₜ) according to an actual voltage regulating demand, thereby significantly simplifying the structure of a multi-input power source, hence reducing the volume of the power source, reducing the cost, and improving the efficiency.

### BRIEF DESCRIPTION OF THE DRAWINGS

FIG. 1 is a structural diagram of a regular power source in the related art;

FIG. 2 is a structural diagram of a power source capable of rapid voltage regulation according to the related art;

FIG. 3 is a structural diagram of a power source according to an embodiment of the disclosure;

FIG. 4 is a structural diagram of a power source according to the first preferred embodiment of the disclosure;

FIG. 5 is a waveform diagram according to the first preferred embodiment of the disclosure;

FIG. 6 is a structural diagram of a power source having an isolating function according to the first preferred embodiment corresponding to FIG. 4;

FIG. 7 is a structural diagram of a power source according to the second preferred embodiment of the disclosure;

FIG. 8 is a structural diagram of a power source having an isolating function according to the second preferred embodiment corresponding to FIG. 7; and

FIG. 9 is a flowchart of a power source voltage regulating method according to an embodiment of the disclosure.

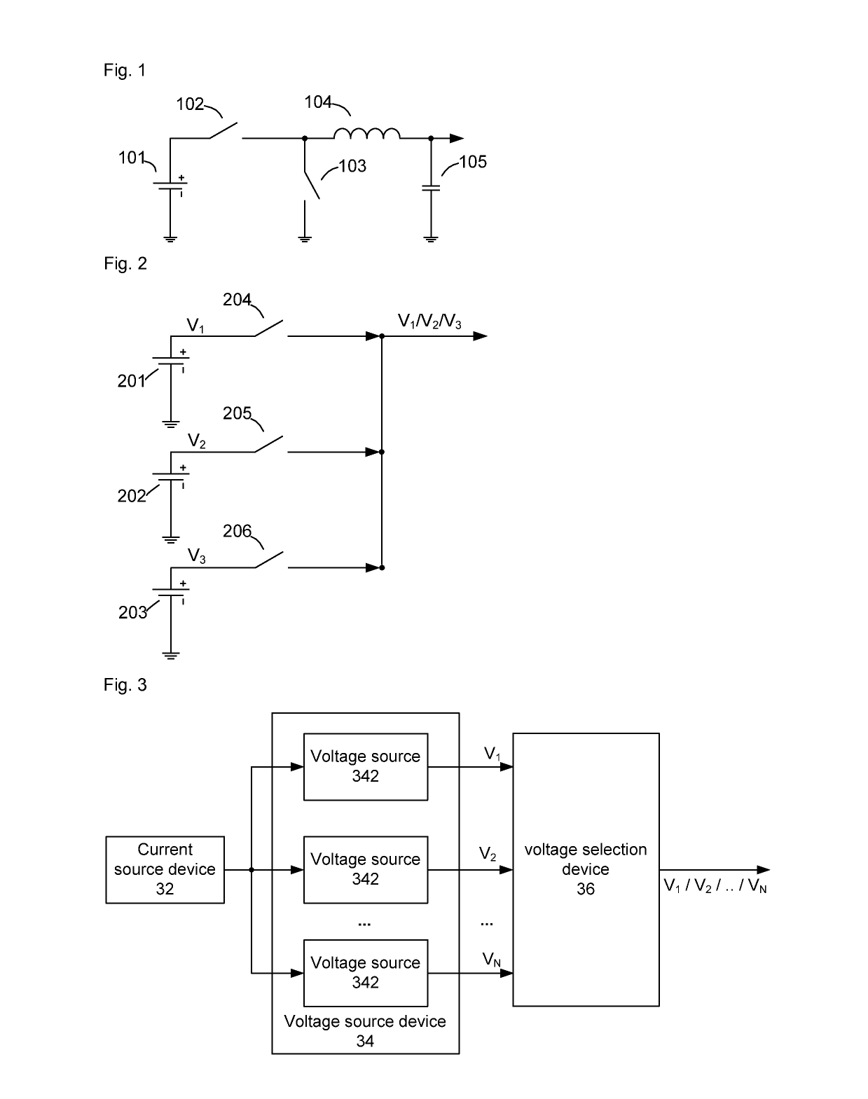

### DETAILED DESCRIPTION

It should be noted that the embodiments of the disclosure and the characteristics in embodiments may be combined with each other if there is no conflict. The disclosure will be described in details below with reference to the drawings and in combination with the embodiments.

The embodiments of the disclosure provide a power source. FIG. 3 is a structural diagram of a power source according to an embodiment of the disclosure. As shown in FIG. 3, the power source includes: a current source device 32, a voltage source device 34, and a voltage selection device 36, and the structure of the power source will be described in details below.

The current source device 32 is configured to provide a current signal to the voltage source device 34; the voltage source device 34 is connected to the current source device 32, includes multiple voltage sources 342, and is configured to convert the current signal from the current source device 32 into a voltage signal; the voltage selection device 36 is connected to the voltage source device 34, and is configured to select one of voltage signals from multiple voltage sources 342 as an output voltage signal.

In the related art, a voltage regulating power source is slow in voltage regulation and low in efficiency. In the embodiment of the disclosure, one current source device is used to supply power to multiple voltage sources in the voltage source device, so as to maintain the output voltages (V₁ to V_{N}) of the voltage sources stable; the voltage selection device selects the output of one of the voltage sources as an ultimate output voltage (Vₒᵤₜ) according to an actual voltage regulating demand, thereby significantly simplifying the structure of a multi-input power source, hence reducing the volume of the power source, reducing the cost, and improving the efficiency.

The current source device 32 may be implemented by at least two methods as follows:

(1) the current source device 32 includes: a first input power source, a first switch, a second switch and a first inductor, wherein a cathode of the first input power source is grounded, and an anode is connected to one end of the first switch; the other end of the first switch is connected to the second switch and the first inductor, and the second switch is grounded; the other end of the first inductor is an output end of the current source device 32;
preferably, besides the first input power source, the first switch, the second switch and the first inductor, the current source device 32 may further include an isolating circuit configured to implement an isolating function, i.e. an output voltage and an input power source are different in reference grounds; the isolating circuit includes, but is not limited to one of the followings: a forward converter, a flyback converter, a bridge circuit and a push-pull circuit; an isolating device in the isolating circuit is a transformer.

Description is provided below by taking a transformer as an example. To implement the isolating function, the current source device 32 further includes a transformer and a third switch, wherein one end of a primary side of the transformer is connected to the anode of the first input power source, and the other end is connected to one end of the third switch; the other end of the third switch is connected to the cathode of the first input power source; one end of a secondary side of the transformer is connected to the first switch, and the other end is connected to a grounded end of the second switch.

(2) the current source device 32 includes: a second input power source, a second inductor and a fourth switch, wherein a cathode of the second input power source is grounded, and an anode is connected to one end of the second inductor; the other end of the second inductor is an output end of the current source device 32 and connected to one end of the fourth switch, and the other end of the fourth switch is grounded.

In such an implementation method, in order to implement the isolating function, the current source device 32 further includes: a third input power source, an insolating circuit and a fifth switch, wherein the isolating circuit includes, but is not limited to one of the followings: a forward converter, a flyback converter, a bridge circuit and a push-pull circuit; an isolating device in the isolating circuit is a transformer.

To describe by taking a transformer as an example, the connecting relations of all components are as follows: a cathode of the third input power source is grounded, and an anode is connected to one end of a primary side of the transformer; the other end of the primary side is connected to one end of the fifth switch; the other end of the fifth switch is connected to the cathode of the third input power source; one end of a secondary side of the transformer is connected to an output end of the current source device 32 and the other end is grounded.

The voltage source 342 includes: a sixth switch and a capacitor, wherein one end of the sixth switch is connected to the current source device 32, and the other end is an output end of the voltage source and connected to one end of the capacitor; the other end of the capacitor is grounded. The voltage source 342 is simple in structure, thus saving the cost of the power source.

Preferably, the voltage selection device 36 includes multiple switches respectively connected to multiple voltage sources in the voltage source device.

Preferably, the switches include, but are not limited to at least one of the followings: triodes, MOS tubes, diodes, and JFETs. Specifically, the switches may consist of triodes, MOS tubes, diodes, or a combination of the three kinds of devices above. In order to prevent the problem of a short circuit of the voltage source caused by a unidirectional blocking switch device such as a triode and an MOS tube etc., the switches may also consists of switch devices such as JFETs having a bidirectional blocking characteristic. Of course, besides the switches above, switches of other types are also applicable to the disclosure.

The power source has a rapid voltage regulating function and may be applied to a power supply device of a radio frequency amplifier.

To make the technical solutions and implementation methods of the disclosure clearer, several specific implementation methods of the power source will be described in details below in conjunction with preferred embodiments.

### Preferred Embodiment 1

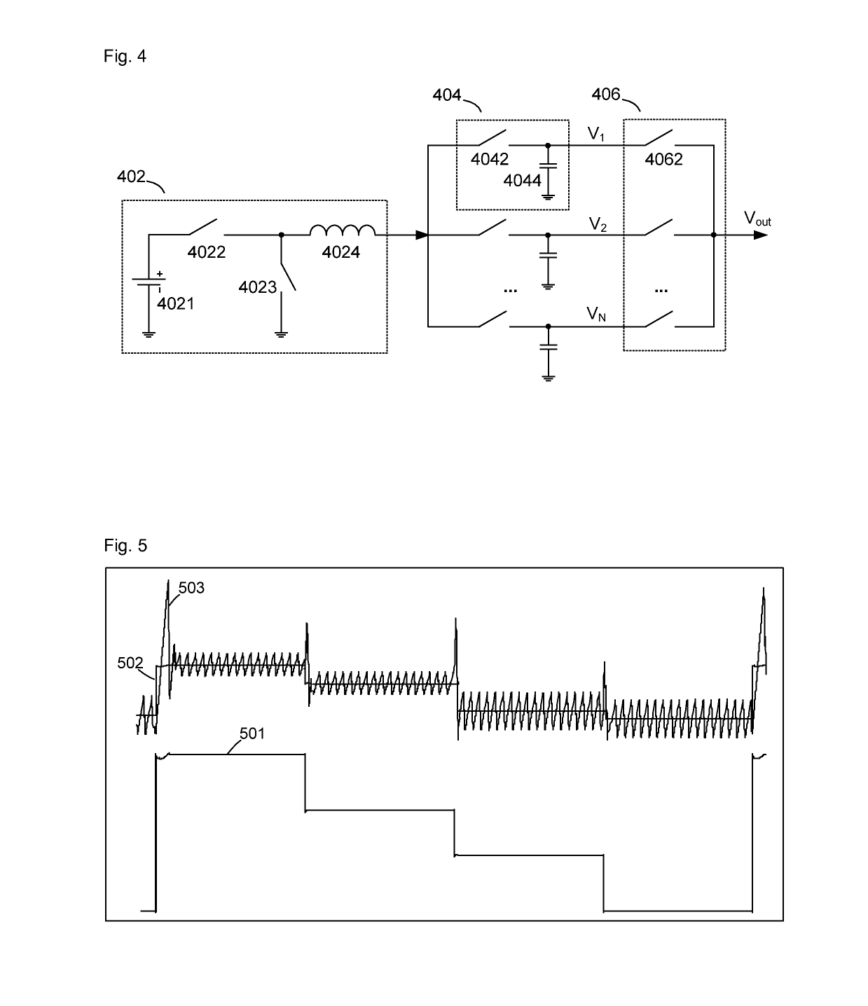

FIG. 4 is a structural diagram of a power source according to the first preferred embodiment of the disclosure. As shown in FIG. 4, in the preferred embodiment, a current source device 402 is a possible specific implementation circuit in the current source device 32 in FIG. 3 and includes: an input power source 4021, a first switch 4022, a second switch 4023 and an inductor 4024, wherein, when the first switch 4022 is turned on and the second switch 4023 is turned off, the input power source 4021 charges the inductor 4024, and a current of the inductor increases; when the first switch 4022 is turned off and the second switch 4023 is turned on, the current of the inductor decreases.

A voltage source 404 is a possible implementation mode of the voltage source 342 in the voltage source device 34 in FIG. 3, and includes a third switch 4042 and a capacitor 4044. When the third switch 4042 is turned on, the current of the inductor charges the capacitor 4044 to maintain the output voltage V₁ of the voltage source 404 stable. Correspondingly, the output voltages V₂ to V_{N} of other voltage sources are maintained stable through the current of the capacitor.

A voltage selection circuit 406 is a possible implementation circuit of the voltage selection device 36 in FIG. 3. When a fourth switch 4062 is turned on, an input voltage V₁ is introduced selectively as an output voltage Vₒᵤₜ. Correspondingly, when a certain switch is turned on, an output voltage (V₁ to V_{N}) of a voltage source corresponding to the switch will be taken as an output voltage Vₒᵤₜ of the whole power source.

To further facilitate understanding, FIG. 5 shows an illustrative waveform corresponding to the preferred embodiment. 501 is an output voltage of a rapid voltage regulating power source, 502 is a load current (e.g. a resistance load) and 503 is an output current of the current source device 402.

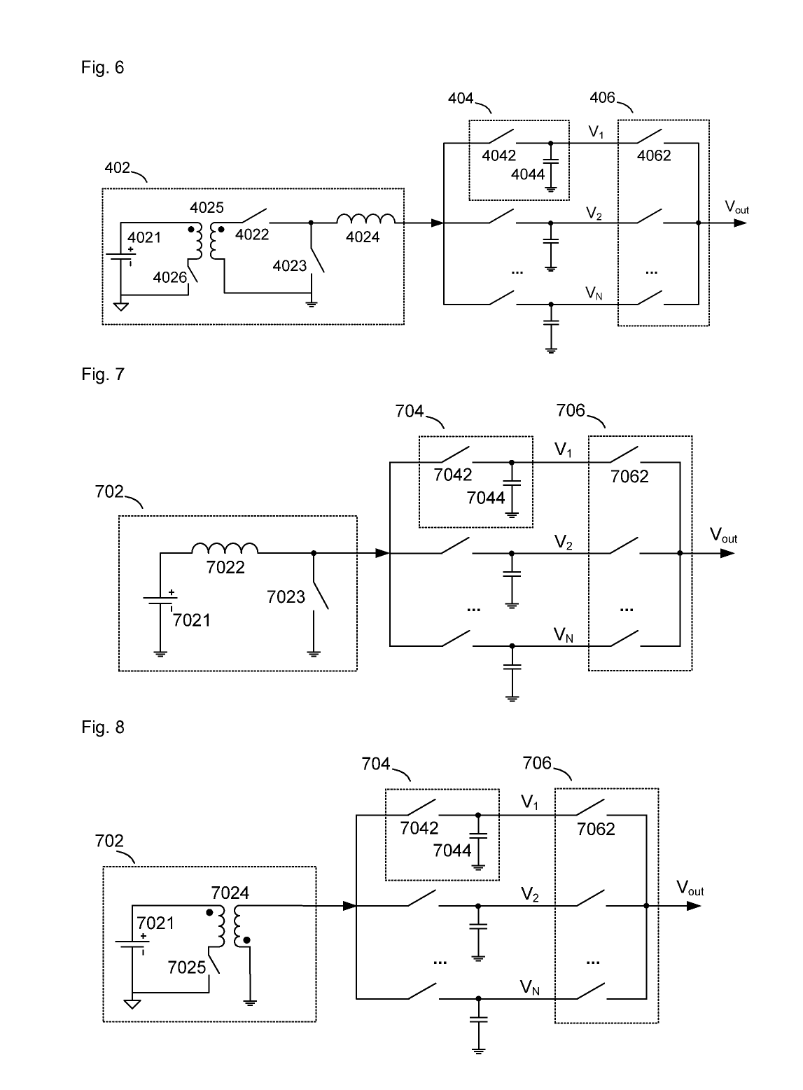

FIG. 6 is a structural diagram of a power source having an isolating function according to the first preferred embodiment corresponding to FIG. 4. The isolating function means that the reference grounds of an output voltage and an input power source may be different. As shown in FIG. 6, the current source device 402 is a possible specific implementation circuit having an isolating function of the current source device 32 in FIG. 3 and the isolating function of the input and output is implemented by a transformer 4025. When a fifth switch 4026 is turned on, a voltage of the input power source 4021 is sensed to the secondary side through the transformer 4025 and the inductor 4024 is charged through turning on the first switch 4022; when the fifth switch 4026 is turned off, the current of the inductor is supplemented through the second switch 4023. Specifically, the isolating function in the preferred embodiment may be also implemented by other expanded circuits, e.g. common topologies including double-tube forward converters, flyback converters, bridge circuits and push-pull circuits etc. in the field of isolating power sources.

### Preferred Embodiment 2

FIG. 7 is a structural diagram of a power source according to the second preferred embodiment of the disclosure. As shown in FIG. 7, a current source device 702 is another possible specific implementation circuit of the current source device 32 in FIG. 3. When a first switch 7023 is turned on, an input power source 7021 charges an inductor 7022 and a current of the inductor increases; when the first switch 7023 is turned off, the current of the inductor charges a subsequent voltage source. Other parts accord with the structure as shown in FIG. 4 and will not be repeated here.

FIG. 8 is a structural diagram of a power source having an isolating function according to the second preferred embodiment corresponding to FIG. 7. In FIG. 8, the current source device 702 is another possible specific implementation circuit having an isolating function of the current source device 32 in FIG. 3, and the input and output isolating function is implemented by a transformer 7024. When a second switch 7025 is turned on, the input power source 7021 charges a primary side magnetizing inductor of the transformer 7024; when the second switch 7025 is turned off, a current of the primary side magnetizing inductor is switched back to the secondary side through the transformer 7024 so as to form an output current of the current source device 702 and charge a subsequent voltage source.

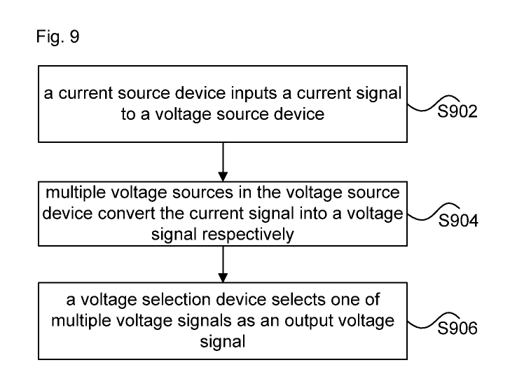

The embodiments of the disclosure further provide a power source voltage regulating method. The power source voltage regulating method may be implemented based on any one of the above power sources. FIG. 9 is a flowchart of a power source voltage regulating method according to an embodiment of the disclosure. As shown in FIG. 9, the method includes step 902 to step 906 as follows.

Step 902: a current source device inputs a current signal to a voltage source device;

Step 904: multiple voltage sources in the voltage source device convert the current signal into a voltage signal respectively;

Step 906: a voltage selection device selects one of multiple voltage signals as an output voltage signal;

Step 906 includes: the voltage selection device acquires different voltage magnitudes as output voltage signals through turning on different switches.

Preferably, the acquiring different voltage magnitudes through turning on different switches by the voltage selection device includes: turning on a switch in a voltage source, which is connected to a turned-on switch in the voltage selection device; a capacitor in a voltage source and the current source device form a voltage-stabilizing direct current power source (e.g. a Buck structure direct current power source or other voltage-stabilizing direct current power sources having a complement structure may be formed) to maintain voltage stabilization of the output of the power source under a load.

Preferably, the inputting the current signal to the voltage source device by the current source device includes: controlling an input power source in the current source device to charge an inductor; when a switch in the voltage source is turned on, a current in the inductor charges a capacitor in the voltage source.

Since a branch (including a voltage source and a switch in the voltage selection device connected to the voltage source) which is disconnected currently is not loaded, the output voltage of the voltage source may be maintained by the capacitor in the voltage source.

In the embodiments above, voltage regulation is realized efficiently by means of voltage selection. In addition, an independent input power source is applied to work simultaneously, thus realizing a simple structure, reducing the volume and cost. There are no other power sources working without load, thus realizing higher efficiency and faster voltage regulation response.

To sum up, a power source and a power source voltage regulating method are provided according to the embodiments of the disclosure. By means of the disclosure, one current source device is used to supply power to multiple voltage sources in the voltage source device, so as to maintain the output voltages (V₁ to V_{N}) of the voltage sources stable; the voltage selection device selects the output of one of the voltage sources as an ultimate output voltage (Vₒᵤₜ) according to an actual voltage regulating demand, thereby significantly simplifying the structure of a multi-input power source, hence reducing the volume of the power source, reducing the cost, and improving the efficiency.

Apparently, those skilled in the art should understand, that each module or each step of the embodiments of the disclosure can be realized with general computing devices; they can be centralized on a single computing device or distributed in a network consisting of multiple computing devices; alternatively, they can be realized through program codes that can be executed by computing devices so that they can be stored in storage devices and executed by computing devices, or they can be manufactured as each integrated circuit module respectively, or several modules or steps of them can be manufactured as a single integrated circuit. In this way, the disclosure is not limited to any specific combination of hardware and software.

The foregoing description is only for preferred embodiments of the disclosure, and shall not limit the disclosure. Those skilled in the art should understand that the disclosure can have various modifications and alternations. Any modifications, equivalent replacements or improvements without departing the spirits and principles of the disclosure shall belong to the protection scope of the disclosure.

What is claimed is:

1. A power source, comprising: a current source device, a voltage source device, and a voltage selection device, wherein the current source device is configured to provide a current signal to the voltage source device;
the voltage source device is connected to the current source device, comprises multiple voltage sources, and is configured to convert the current signal from the current source device into a voltage signal;
the voltage selection device is connected to the voltage source device, and is configured to select one of voltage signals from multiple voltage sources as an output voltage signal.

2. The power source according to claim 1, wherein the current source device comprises: a first input power source, a first switch, a second switch and a first inductor, wherein
a cathode of the first input power source is grounded and an anode is connected to one end of the first switch;
the other end of the first switch is connected to the second switch and the first inductor, and the second switch is grounded;
the other end of the first inductor is an output end of the current source device.

3. The power source according to claim 2, wherein the current source device further comprises an isolating circuit, wherein the isolating circuit comprises one of the followings: a forward converter, a flyback converter, a bridge circuit and a push-pull circuit; an isolating device in the isolating circuit is a transformer.

4. The power source according to claim 3, wherein the current source device further comprises a third switch, wherein
one end of a primary side of the transformer is connected to the anode of the first input power source, and the other end is connected to one end of the third switch; the other end of the third switch is connected to the cathode of the input power source;
one end of a secondary side of the transformer is connected to the first switch, and the other end is connected to the grounded end of the second switch.

5. The power source according to claim 1, wherein the current source device comprises: a second input power source, a second inductor and a fourth switch, wherein
a cathode of the second input power source is grounded, and an anode is connected to one end of the second inductor;
the other end of the inductor is an output end of the current source device and connected to one end of the fourth switch, and the other end of the fourth switch is grounded.

6. The power source according to claim 5, wherein the current source device further comprises: a third input power source, an insolating circuit and a fifth switch; the isolating circuit comprises one of the followings: a forward converter, a flyback converter, a bridge circuit and a push-pull circuit; an isolating device in the isolating circuit is a transformer.

7. The power source according to claim 6, wherein a cathode of the third input power source is grounded and an anode is connected to one end of a primary side of the transformer; the other end of the primary side is connected to one end of the fifth switch; the other end of the fifth switch is connected to the cathode of the third input power source; one end of a secondary side of the transformer is an output end of the current source device and the other end is grounded.

8. The power source according to claim 1, wherein the voltage source comprises: a sixth switch and a capacitor; one end of the sixth switch is connected to the current source device, the other end is an output end of the voltage source device and connected to one end of the capacitor; the other end of the capacitor is grounded.

9. The power source according to claim 1, wherein the voltage selection device comprises multiple switches respectively connected to multiple voltage sources in the voltage source device.

10. The power source according to claim 2, wherein the switches include at least one of the followings: triodes, Metal-Oxide-Semiconductor (MOS) tubes, diodes, and Junction Field-Effect Transistors (JFET).

11. A power source voltage regulating method, comprising:
inputting, by a current source device, a current signal to a voltage source device;
converting, by multiple voltage sources in the voltage source device, the current signal into a voltage signal respectively;
selecting, by a voltage selection device, one of multiple voltage signals as an output voltage signal.

12. The method according to claim 11, wherein the selecting one of the multiple voltage signals as the output voltage signal by the voltage selection device comprises:
acquiring, by the voltage selection device, different voltage magnitudes as the output voltage signals through turning on different switches.

13. The method according to claim 12, wherein the acquiring different voltage magnitudes through turning on different switches by the voltage selection device comprises:
turning on a switch in a voltage source, which is connected to a turned-on switch in the voltage selection device; a capacitor in the voltage source and the current source device form a voltage-stabilizing direct current power source to maintain voltage stabilization of the output of the power source under a load.

14. The method according to claim 11, wherein the inputting the current signal to the voltage source device by the current source device comprises:
controlling an input power source in the current source device to charge an inductor;
when a switch in the voltage source is turned on, charging, by a current of the inductor, a capacitor in the voltage source.

15. The method according to claim 11, wherein, when the voltage source and a switch in the voltage selection device connected to the voltage source are disconnected, maintaining an output voltage of the voltage source by a capacitor in the voltage source.
